(19) United States
(12) Patent Application Publication
(10) Pub. No.: US 2014/0284193 A1
(43) Pub. Date: Sep. 25, 2014

(54) COMMAND GENERATION STRUCTURE FOR THIN KEYBOARDS

(71) Applicant: ZIPPY TECHNOLOGY CORP., New Taipei City (TW)

(72) Inventor: Chin-Wen CHOU, New Taipei City (TW)

(73) Assignee: ZIPPY TECHNOLOGY CORP., New Taipei City (TW)

(21) Appl. No.: 13/848,344

(22) Filed: Mar. 21, 2013

(51) Int. Cl. H01H 13/76

(52) U.S. Cl. CPC H01H 13/76
USPC 200/5 A

(57) ABSTRACT

A command generation structure for thin keyboards includes a circuit board and a frame stacked over the circuit board. The circuit board has a plurality of keyboard command portions to receive contact to generate command signals. The frame includes a plurality of housing zones corresponding to the keyboard command portions, at least two connection arms extended from any two diagonal corner positions of each housing zone towards the keyboard command portion, and at least one press member connected to the connection arms and depressible to contact the keyboard command portion. Each connection arm has at least one first connecting section connected to one corner position, at least one second connecting section connected to the press member, and an elastic section which bridges the first connecting section and second connecting section and has at least one stress bend spot.

### FIELD OF THE INVENTION

The present invention relates to a command generation structure located in a thin keyboard and particularly to a command generation structure with connection arms to replace a conventional driven mechanism to make the keyboard thinner.

### BACKGROUND OF THE INVENTION

Conventional keyboards such as those disclosed in TW patent Nos. 445471, 1220213 and M346861 generally include a keycap, a circuit board triggered by the keycap to generate a command signal, a baseboard located at one side of the circuit board and a driven mechanism with two ends connecting to the keycap and baseboard. The keycap is depressible to move towards the circuit board. The driven mechanism is depressed downwards to contact and set on a circuit switch on the circuit board to generate a corresponding command signal. If the keycap is not depressed to move towards the circuit board, the driven mechanism provides an elastic return force to push the keycap to move away from the circuit board at a selected distance in normal conditions. While the conventional keyboard structure can achieve the object of command input, it is constrained by the height of the driven mechanism and the structure itself that make the keyboard thicker. In view of the prevailing trend of computer design that heavily focuses on thinness and lightness, especially the notebook computers, the thickness ratio of keyboard module is the main factor affecting the total computer thickness. Hence all producers have devoted a great deal of efforts trying to make the keyboard structure thinner to reduce the total thickness.

In order to overcome the aforesaid problem, some producers have proposed another keyboard design, such as TW patent No. M434979 which provides a V-shaped structure consisting of a first support member and a second support member to solve the thickness problem caused by the X-shaped structure of the conventional driven mechanism; or patent No. M419973 which provides an extensible lift structure located between the keycap and circuit board to replace the conventional driven mechanism; or TW patent No. M426075 which provides a first support member and a second support member around the keycap to replace the conventional driven mechanism. Although the aforesaid keyboard structures can reduce the total thickness of the keyboard, they merely provide the driven mechanism in other forms, thus still have a certain thickness. Moreover, the keyboards they provided are difficult to make and assemble.

SUMMARY OF THE INVENTION

The primary object of the present invention is to provide a command generation structure for a thin keyboard that provides connection arms to support a press member to overcome the constraint of driven mechanism in the conventional keyboard that makes thinness of the keyboard difficult.

To achieve the foregoing object, the command generation structure of the invention includes a circuit board and a frame stacked over the circuit board. The circuit board has a plurality of keyboard command portions to receive contact and generate command signals. The frame includes a plurality of housing zones corresponding to the keyboard command portions, at least two connection arms extended from any two diagonal corner positions of each housing zone towards each keyboard command portion, and at least one press member connected to the connection arms and depressible to contact the keyboard command portion. Each connection arm has at least one first connecting section connected to one corner position, at least one second connecting section connected to the press member, and an elastic section which bridges the first connecting section and second connecting section and has at least one stress bend spot.

In one embodiment the command generation structure further includes at least an. elastic support member interposed between the circuit board and frame, and corresponding to each keyboard command portion.

In another embodiment the elastic support member includes a trigger portion depressible by the press member to contact the circuit board to generate the command signal. The elastic support member is a sponge or an elastic element.

In yet another embodiment the elastic support member includes a trigger portion depressible by the press member to contact the circuit board to generate the command signal and a plurality of bracing petals integrally extended from the trigger portion and depressible by the press member to generate deformation and provide elastic return force.

In yet another embodiment the command generation structure further includes at least one keycap corresponding to each press member for coupling thereon.

In yet another embodiment the keycap has a character symbol coated on the surface thereof to indicate each press member.

In yet another embodiment the command generation structure further includes a sandwiched plate interposed between the press member and keycap and marked with a character symbol thereon.

In yet another embodiment the press member has a character symbol coated on the surface thereof to indicate each press member.

In yet another embodiment the command generation structure further includes a lighting structure which has a lighting module and a baseboard corresponding to the circuit board.

In yet another embodiment the lighting structure further includes a light guide plate located between the keycap and baseboard to transmit light.

In yet another embodiment the circuit board includes at least one light permeable zone corresponding to each housing zone and a light impermeable zone.

In yet another embodiment the frame further includes an optical mask layer to confine light to pass merely through the housing zones.

By means of the construction set forth above, compared with the conventional command generation structure, the command generation structure of the invention provides features as follows:

1. The keyboard can be made thinner. The invention, with the press member supported by the connection arms, can be suspended over the circuit board at a desired distance, and also provide a return force for the press member after being depressed, thereby can replace the conventional driven mechanism to overcome the height constraint and make the keyboard thinner.

2. Simpler production and assembly. The invention provides the frame with the connection arms to replace the conventional driven mechanism, such that the complicated assembly processes of the driven mechanism can be omitted to make assembly of the keyboard much simpler.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a top view of a first embodiment of the frame of the invention.

FIG. 2 is an exploded view of a first embodiment of the command generation structure of the invention.

FIG. 3 is another exploded view of the first embodiment of the command generation structure of the invention seen from another visual angle.

FIG. 4 is a schematic view of a first embodiment of the invention in a pressed condition.

FIG. 5 is an exploded view of a second embodiment of the command generation structure of the invention.

FIG. 6 is an exploded view of a third embodiment of the command generation structure of the invention.

FIG. 7 is an exploded view of a fourth embodiment of the command generation structure of the invention.

FIG. 8 is an exploded view of a fifth embodiment of the command generation structure of the invention.

FIG. 9 is a top of a sixth embodiment of the frame of the invention.

### DETAILED DESCRIPTION OF THE PREFERRED EMBODIMENTS

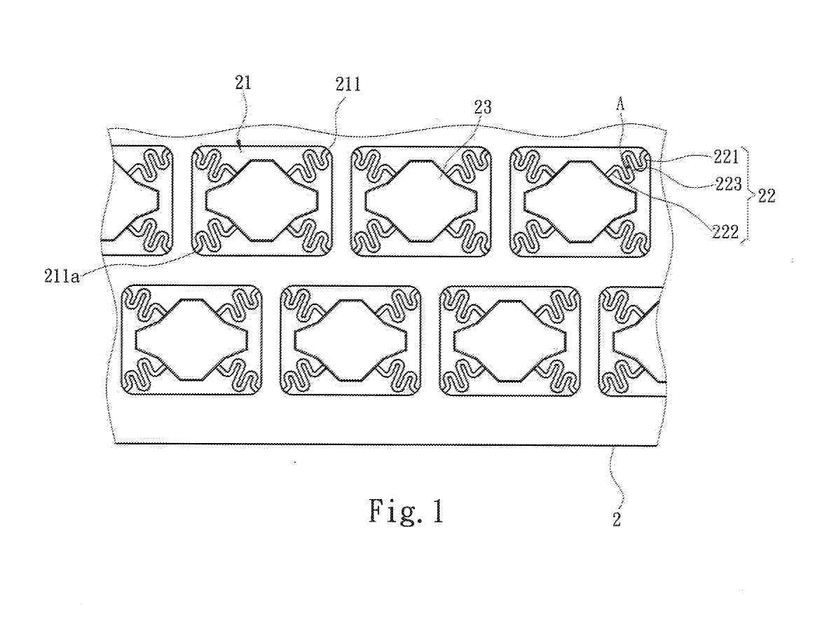

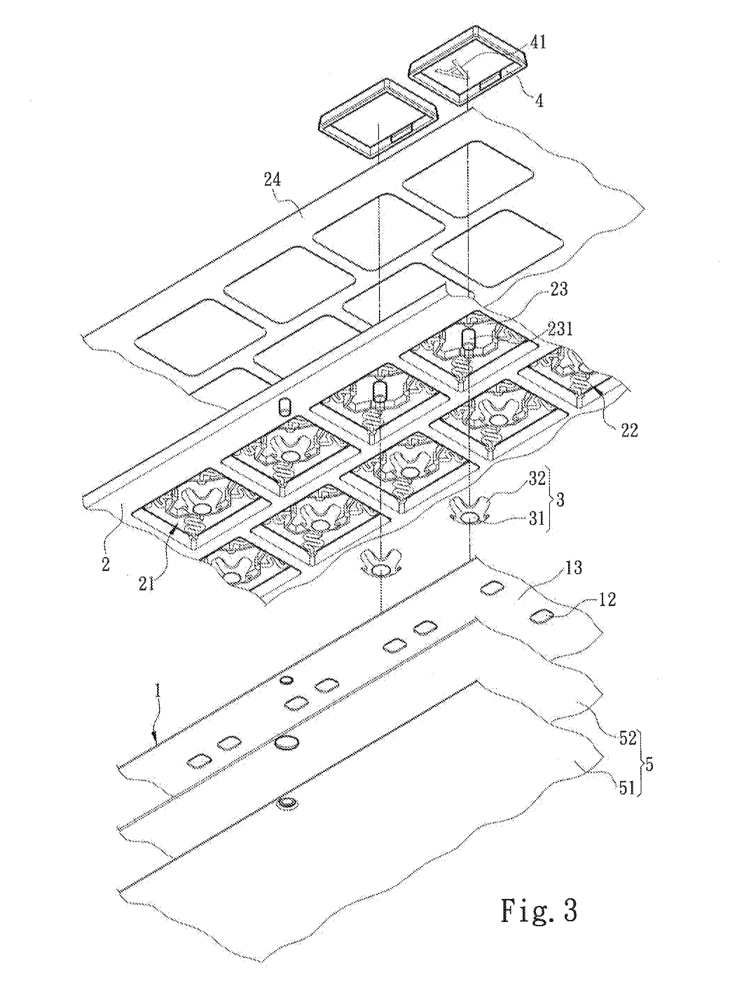

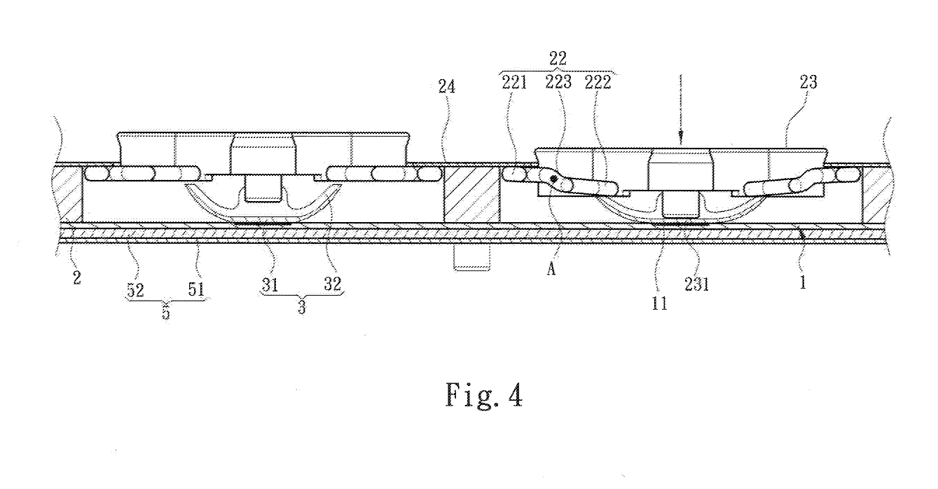

Please refer to FIGS. 1 through 4, the present invention aims to provide a command generation structure for a thin keyboard to save the driven mechanism used in the conventional command generation structure to further reduce total thickness of the keyboard. The command generation structure of the invention comprises a circuit board 1 and a frame 2 stacked over the circuit board 1. The circuit board 1 has a plurality of keyboard command portions 11 to receive contact and generate command signals. The frame 2 includes a plurality of housing zones 21 corresponding to the keyboard command portions 11. Furthermore, each housing zone 21 has a plurality of corner positions 211. The frame 2 further includes at least two connection arms 22 extended from any two diagonal corner positions 211 and 211a of each housing zone 21 towards the keyboard command portion 11, and at least one press member 23 connected to the connection arms 22 and depressible to contact the keyboard command portion 11. Each connection arm 22 has at least one first connecting section 221 connected to the corner position 211, at least one second connecting section 222 connected to the press member 23, and an elastic section 223 which bridges the first connecting section 221 and second connecting section 222 and has at least one stress bend spot A. Also referring to FIG. 4, when the connection arms 22 do not receive forces to be deformed, namely the press member 23 does not move towards the circuit board 1, the connection arms 22 support the press member 23 to allow the press member 23 to suspend from the keyboard command portion 11 at a selected distance without contacting therewith, hence no command signal is generated. In the event that the press member 23 is depressed by an external force to move towards the circuit board 1, the connection arms 22 are driven and deformed as shown in FIG. 4. The second connecting section 222 is moved towards the circuit board 1. During the depressing process a stress is generated which is dissipated at the stress bend spot A of the elastic section 223. When the external force is absent, the elastic section 223 returns to the original non-depressed state through the stress bend spot A.

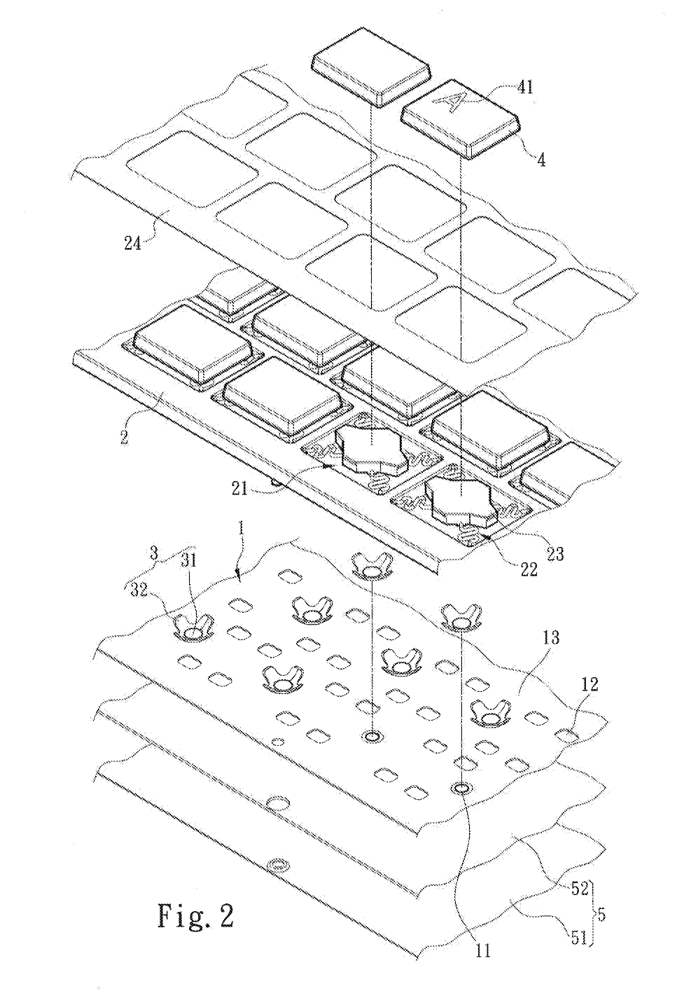

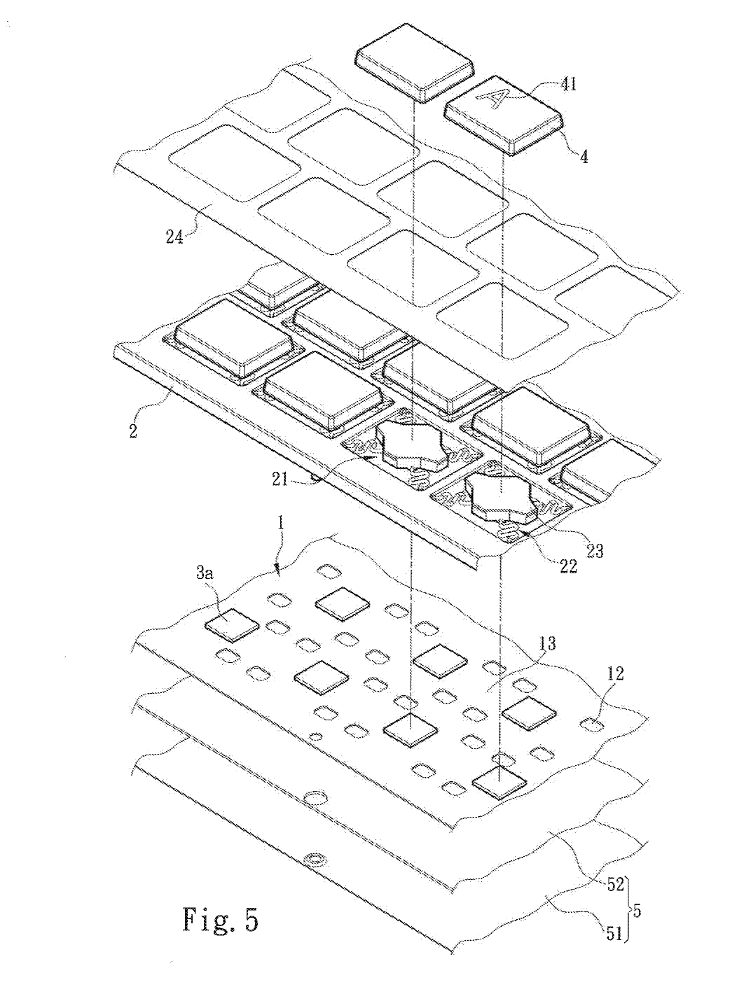

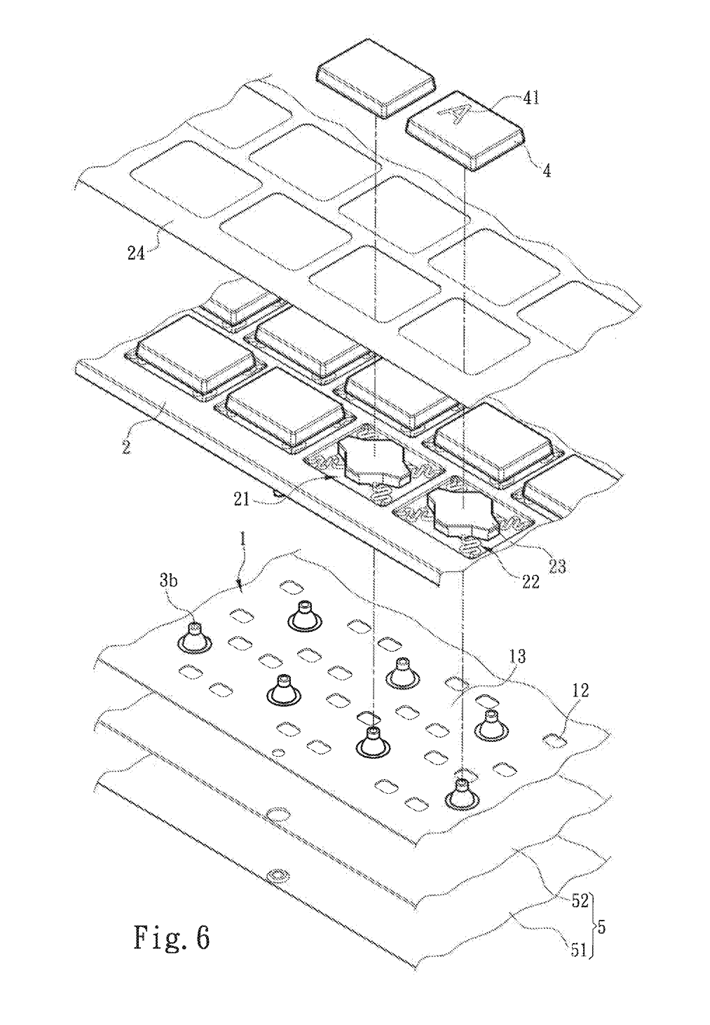

Please refer to FIGS. 1 through 4 again, the command generation structure further includes an elastic support member 3 interposed between the circuit board 1 and frame 2 corresponding to one keyboard command portion 11. When the press member 23 is depressed to move towards the circuit board 1, the elastic support member 3 is pressed by the press member 23 to generate deformation to allow the keyboard command portion 11 on the circuit board 1 to generate a command signal. When the external force exerting to the press member 23 is absent, the elastic support member 3 pushes the press member 23 through its own elastic return force to the original non-depressed condition. More specifically, the elastic support member 3 can include a trigger portion 31 depressible by the press member 23 to contact the circuit board 1 to generate the command signal. The elastic support member 3 can be formed in many styles, such as a sponge 3a (referring to FIG. 5), an elastic reed (not shown in the drawings) or an elastic element 3b (referring to FIG. 6) used in the conventional keyboard structure, The sponge 3a can be provided at a local location or formed in an entire sheet. Aside from the embodiments previously discussed that the elastic support member 3 has the trigger portion 31, the elastic support member 3 also has a plurality of bracing petals 32 which are integrally extended from the trigger portion 31 and depressible by the press member 23 to produce deformation and provide the elastic return force. In this embodiment, the elastic support member 3 contains the bracing petals 32 as shown in FIG. 2. In addition, the press member 23 can further include a butting portion 231 corresponding to each keyboard command portion 11 to be in contact therewith when the press member 23 is depressed and moved towards the circuit board 1.

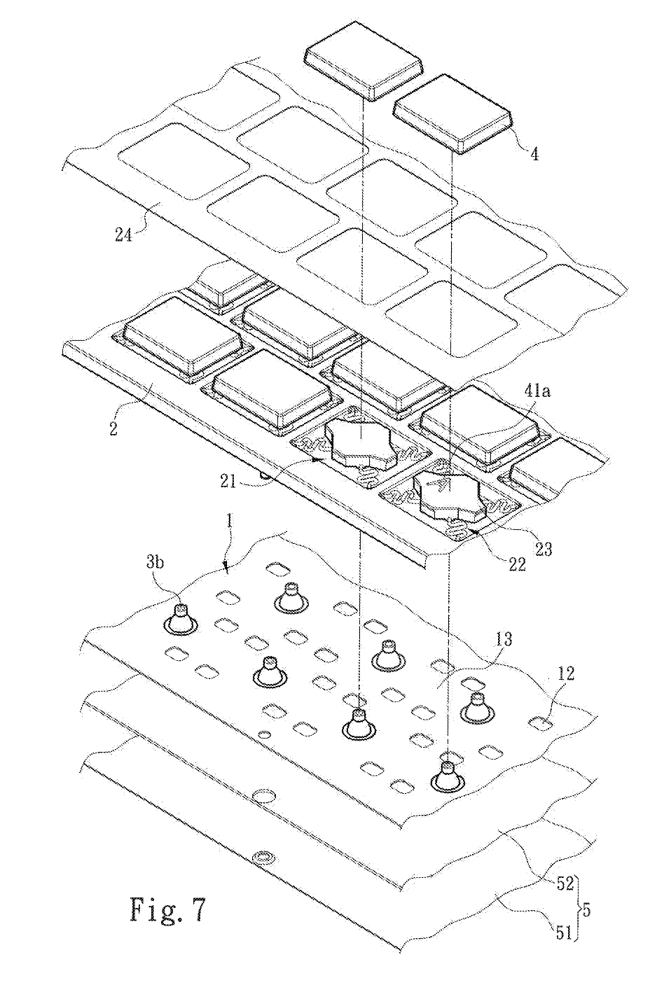

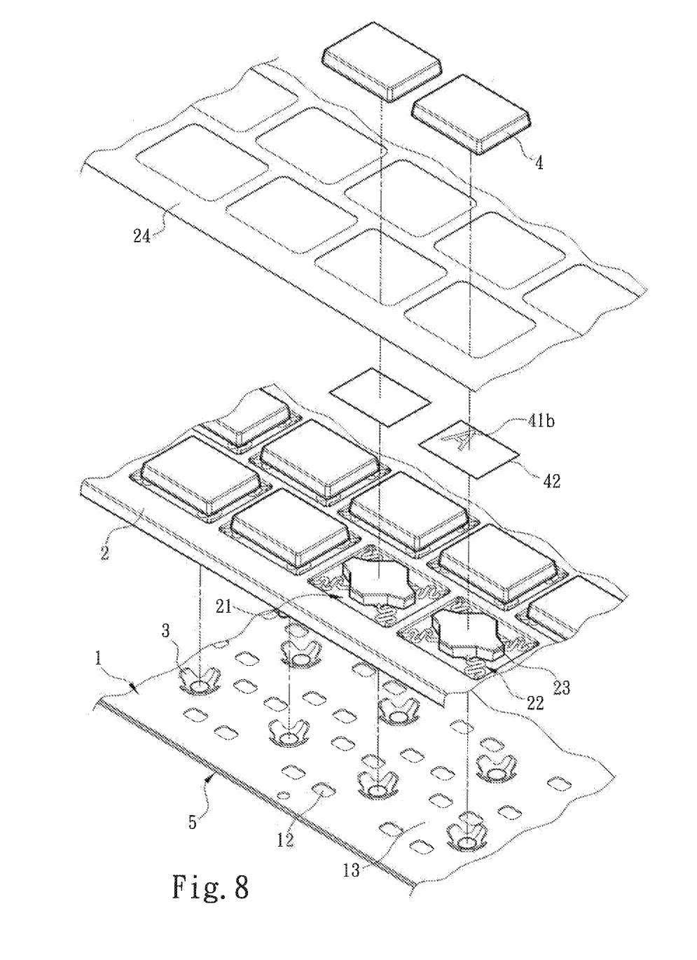

Also referring to FIG. 2, the invention can further include at least one keycap 4 corresponding to each press member 23 for coupling thereon, The keycap 4 provides a greater press area to facilitate user's fast keystrokes to generate the command signals. In addition, the keycap 4 further has a character symbol 41 coated on the surface to indicate each press member 23. In practice, the command signal generated by each press member 23 is different. The character symbol 41 allows users to identify each press member 23. Moreover, the character symbol 41a can also be coated on the surface of the press member 23 for indication thereof as shown in FIG. 7. Please refer to FIG. 8, the keycap 4 can further be light permeable. Then a sandwiched plate 42 can be provided and interposed between the keycap 4 and press member 23 and marked with a character symbol 41b printed thereon for indication. The light permeability of the keycap 4 can reveal the character symbol 41b.

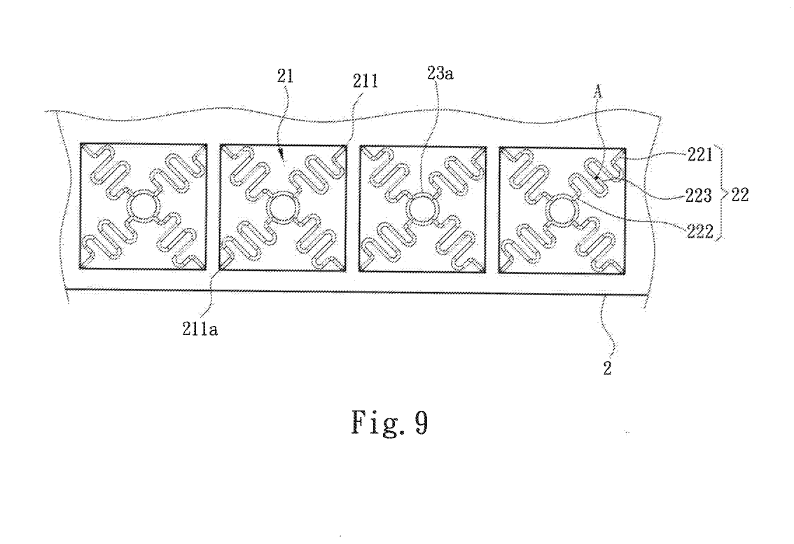

Please refer to FIGS. 1 through 4 again, the command generation structure of the invention can further include a lighting structure 5 which includes a lighting module (not shown in the drawings) and a baseboard 51 corresponding to the circuit board 1. For instance, the lighting module can be a LED module or other electroluminescent lighting modules. In addition, the lighting structure 5 can further include a light guide plate 52 located between the keycap 4 and baseboard 51. The lighting module can be positioned in many ways. The light guide plate 52 can be positioned corresponding to the lighting module, such as stacked over the baseboard 51 or circuit board 1. Moreover, the circuit board 1 also includes at least one light permeable zone 12 corresponding to each housing zone 21 and a light impermeable zone 13, and light transmitted by the lighting module can pass only through the light permeable zone 12 to generate illumination. Furthermore, the frame 2 can further include, an optical mask layer 24 to confine the light to pass merely through the housing zones 21. The optical mask layer 24 can be provided in many ways, such as an optical mask plate located on the frame 2 or made of an optical mask material coated onto the frame 2. It is to be noted that the press member 23 discussed in the previous embodiments is not limited to what have been depicted in the drawings, but can be formed in other styles as desired, such as the press member 23a on the frame 2 shown in FIG. 9.

As a conclusion, the command generation structure of the invention includes a circuit board and a frame stacked over the circuit board. The circuit board has a plurality of keyboard command portions to receive contact and generate command signals. The frame includes a plurality of housing zones corresponding to the keyboard command portions, at least two connection arms extended from any two diagonal corner positions of each housing zone towards the keyboard command portion, and at least one press member connected to the connection arms and depressible to contact keyboard command portion. Each connection arm includes at least one first connecting section connected to the corner position, at least one second connecting section connected to the press member, and an elastic section which bridges the first and second connecting sections and has at least one stress bend spot. The connection arms replace the driven mechanism in the conventional keyboard to generate the same effect thereof. Compared with the conventional keyboard structure, the keyboard of the invention has a thinner total thickness and is not constrained by the height of the driven mechanism, therefore is adaptable to more products aiming at thinness and lightness.

While the preferred embodiments of the invention have been set forth for the purpose of disclosure, they are not the limitation of the invention, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A command generation structure for thin keyboards, comprising:
a circuit board including a plurality of keyboard command portions to receive contact to generate command signals; and
a frame which is stacked over the circuit board and includes a plurality of housing zones each corresponding to one keyboard command portion, at least two connection arms extended from any two diagonal corner positions of each housing zone towards the keyboard command portion and at least one press member connected to the at least two connection arms and depressible to contact the keyboard command portion, each of the at least two connection arms including at least one first connecting section connected to the corner position, at least one second connecting section connected to the press member and an elastic section bridging the first connecting section and the second connecting section and including at least one stress bend spot.

2. The command generation structure of claim 1 further including an elastic support member interposed between the circuit board and the frame corresponding to one keyboard command portion.

3. The command generation structure of claim 2, wherein the elastic support member includes a trigger portion depressible by the press member to contact the circuit board to generate the command signal.

4. The command generation structure of claim 3, wherein the elastic support member is a sponge or an elastic element.

5. The command generation structure of claim 2, wherein the elastic support member includes a trigger portion depressible by the press member to contact the circuit board to generate the command signal and a plurality of bracing petals extended. integrally from the trigger portion and depressible by the press member to generate deformation and provide elastic return force.

6. The command generation structure of claim 1 further including a keycap corresponding to each press member for coupling thereon.

7. The command generation structure of claim 6, wherein the keycap includes a character symbol coated on the surface thereof to indicate the press member.

8. The command generation structure of claim 6 further including a sandwiched plate interposed between the press member and the keycap and marked with a character symbol.

9. The command generation structure of claim 6, wherein the press member includes a character symbol coated on the surface for indication thereof.

10. The command generation structure of claim 1 further including a lighting structure which includes a lighting module and a baseboard corresponding to the circuit board.

11. The command generation structure of claim 10, wherein the lighting structure includes a light guide plate interposed between the keycap and the baseboard to transmit light.

12. The command generation structure of claim 10, wherein the circuit board includes at least one light permeable zone corresponding to each housing zone and a light impermeable zone.

13. The command generation structure of claim 10, wherein the frame includes an optical mask layer to confine light to pass merely through the housing zones.
